(19) United States
(12) Patent Application Publication
(10) Pub. No.: US 2002/0004081 A1
(43) Pub. Date: Jan. 10, 2002

(54) Cooling ring

(76) Inventors: Vadim Raiko, Wuppertal (DE); Stefan Konermann, Remscheid (DE)

Correspondence Address: Richard M. Goldberg, Suite 419, 25 East Salem Street, Hackensack, NJ, 07601, US

(21) Appl. No.: 09/899,777

(22) Filed: Jul. 5, 2001

(30) Foreign Application Priority Data
Jul. 5, 2000 (EP) 00 114 393.2

(51) Int. Cl. B29C 47/88

(52) U.S. Cl. 425/71; 425/72.1

(57) ABSTRACT

A cooling ring for a film blowing line, with a ring chamber, which at a peripheral edge forms an outlet gap for the delivery of a cooling medium onto the film bubble (14) and is divided by radial cross members (24) into several segments (34), and with fittings (30, 32) for homogenizing the flow of the cooling medium in the individual segments (34), wherein the fittings have deflector plates (30), which are disposed obliquely to the radial direction and deflect a portion of the cooling medium from the central regions of the segments (34) to the cross members (24).

The invention relates to a cooling ring for a film blowing line, with a ring chamber, which at a peripheral edge forms an outlet gap for the delivery of a cooling medium onto the film bubble and is divided by radial cross members into several segments, and with fittings for homogenizing the flow of the cooling medium in the individual segments.

A cooling ring of this type is described in EP-B-0 478 641. This cooling ring supplies external cooling air to the film bubble and accordingly has an outlet gap surrounding the film bubble at the inner circumferential edge. By controlling or regulating the throughput of cooling air through the individual segments, it is possible to intensify or attenuate the cooling effect. Since the freshly extruded film is stretched by the air blown into the interior of the film bubble, a more intensive cooling leads to a faster increase in the viscosity of the melt and, with that, to less stretching of the film and consequently to a greater film thickness, while conversely an attenuation of the cooling leads to a reduction in film thickness. In this way, by the controlled, segmental regulation of the cooling air supplied, the thickness profile of the film can be affected selectively and homogenized. The function of the cross members between the individual segments is to keep the flows of cooling air separate from one another in the individual segments up into the vicinity of the outlet gap, so that different throughputs of cooling air are not equalized prematurely.

On the other hand, because of frictional effects and/or because of turbulence of the cooling air, the cross members unavoidably affect the velocity distribution of the cooling air and, with that, the cooling effect. Under certain conditions, such as in the case of particularly sensitive films, this can have the effect that, although the thickness of the film, on the whole, is relatively uniform in the peripheral direction of the blown film, it nevertheless has a certain modulation corresponding to the arrangement of the cross members of the cooling ring. In order to mitigate this effect, it has already been proposed in the publication cited that the flow of cooling air be homogenized by fittings, so that the effect of the cross members becomes less noticeable. These fittings are formed, for example, by radial cross members, which divide each segment into a number of narrower partial segments. In practice, however, an effective homogenization of the cooling air flowing could not be achieved with the methods, which have been proposed.

It is therefore an object of the invention to create a cooling of the type named above, with which a more uniform peripheral distribution of the flow of cooling air can be achieved.

Pursuant to the invention, this objective is accomplished owing to the fact that the fittings have deflector plates, which are disposed obliquely to the radial direction and deflect a portion of the cooling medium from the central regions of the segments in the direction of the cross members.

In conjunction with the cross members of the cooling ring, the deflector plates have the effect of nozzles, by means of which the flow velocity of the cooling air is increased. One might assume, that this would lead to a further homogenization of the flow of cooling air. However, this is not the case. Instead, it is an effective measure for equalizing the disorders, which are brought about by the cross members. Due to the deflector plates, the flow of cooling air receives a velocity component in the circumferential direction of the cooling ring and a portion of the cooling air accordingly is deflected into the “wind shadow” behind the downstream ends of the cross members. As a result, a velocity distribution of the cooling air is obtained, which is significantly more uniform in the circumferential direction of the cooling ring than in the case of the conventional cooling ring. This advantageous affect can be achieved in the case of laminar as well as in the case of turbulent flow of the cooling medium.

Advantageous developments arise out of the dependent claims.

Basically, it is possible to vary the angle of incidence, the position or the length of the deflector plates as a function of the flow velocity of the cooling medium. However, it has turned out that the optimum angle of incidence of the deflector plates, with which a largely uniform flow profile is achieved within the region, in which the flow velocities vary during the normal operation of the cooling ring, hardly depends on the flow velocity, so that the desired effect can be attained with rigidly disposed deflector plates and a correspondingly simple construction of the cooling ring.

Preferably, a radially extending guiding plate, which provides the flow of cooling air, accelerated by the nozzle action, once again with an approximately radial direction, adjoins each obliquely set deflector plate downstream.

In the outer circumferential region, conventional cooling rings as typically have an annular distributing chamber, in which the cooling air, supplied with the help of a blower, is distributed uniformly before it overcomes a damming up step and enters the radially extending segments of the cooling ring. In this case, there is within each segment a flow profile, which is essentially symmetrical to the longitudinal axis of the segment. The fittings are also installed symmetrically to the longitudinal axis of the segment in this case.

It is, however, also possible to supply the cooling medium tangentially to the outer periphery of the cooling ring, so that the cooling air, as it enters the radially extending segments, still has an essentially uniform velocity component in the circumferential direction on the whole periphery. In this case, there is within each segment and asymmetric flow profile, which is then homogenized and, at the same time, largely symmetrized by an appropriate, asymmetric arrangement of the deflector plates.

In the case of an asymmetric arrangement of the fittings, a deflector plate, which forms a nozzle with the cross member in question, is assigned to each of the two cross members, which form the boundary of a segment. A diffuser is then formed between the two deflector plates and expands downstream, thus causing the flow velocity of the cooling air to be decreased in the middle region of the segment. Alternatively, several diffusers, which are nestled one inside the other, can be formed by several pairs of deflector plates and make possible a more accurate control of the velocity profile. In addition, the fittings may also comprise straight, radially extending guiding plates, which divide each segment into several partial segments. Together with one of the deflection plates, a diffuser can then be formed on each side of the guiding plate. It is, however, also possible to dispose two deflector plates, which are set in opposite directions and, between one another, form a diffuser, in each partial segment. The walls of the partial segment, which are formed either by a cross member or by a guiding plate, then form a nozzle together with one of the deflector plates.

The deflector plates preferably are disposed in the vicinity of the downstream ends of the cross members. They may, however, also be disposed at a certain distance downstream or upstream from the downstream ends of the cross members.

In the following, examples of the invention are explained in greater detail by means of the drawings, in which

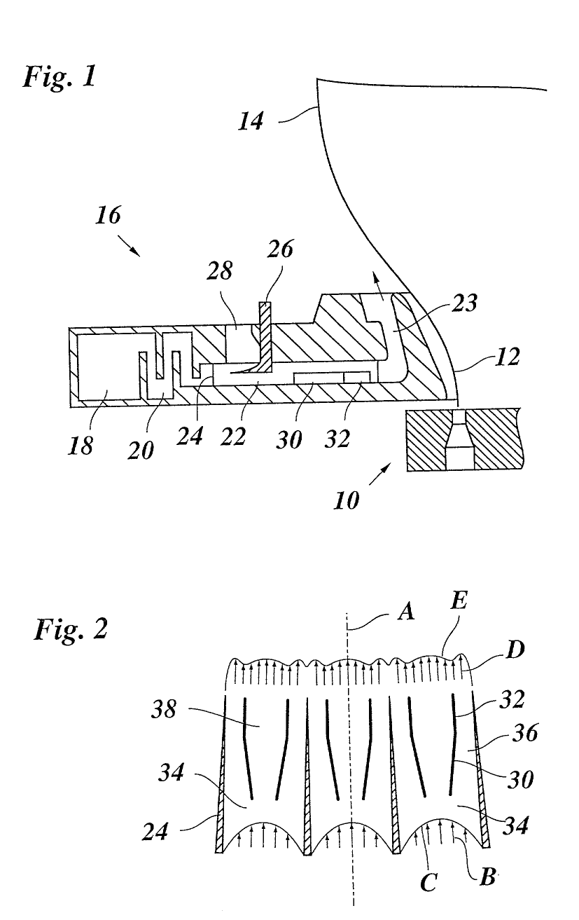

FIG. 1 shows a radial section through a cooling ring at the periphery of a film bubble,

FIG. 2 shows a horizontal partial section through the cooling ring of FIG. 1 and

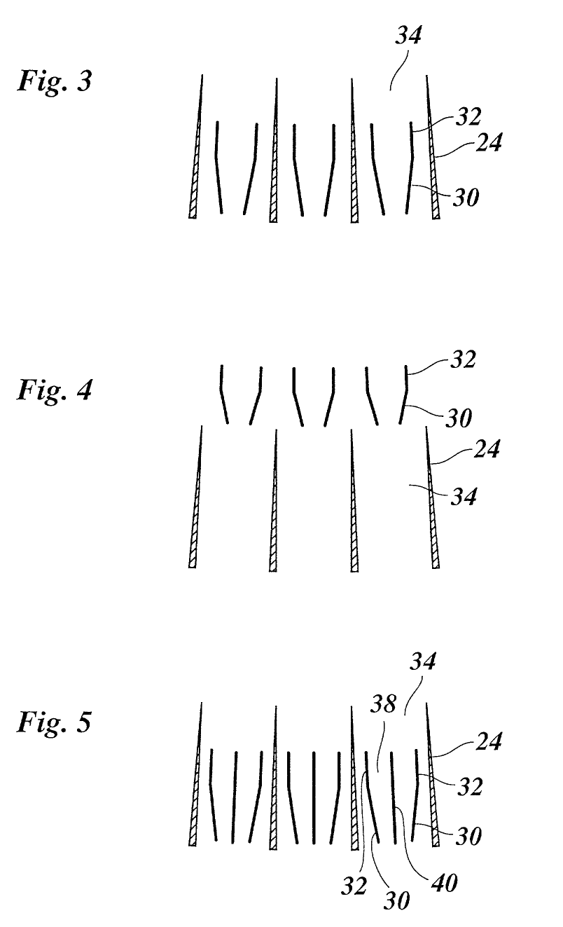

FIGS. 3 to 7 show partial sections through cooling rings of modified embodiments of the invention.

In FIG. 1, a vertical partial section of an annular extrusion die 10 is shown, from which the plastic melt 12 is extruded in the form of a blown film. By blowing in air, the blown film is then expanded in a known manner to a film bubble 14, so that the film material is stretched before it solidifies. In order to accelerate the solidification of the film material, cooling air is blown on the film bubble 14 in the stretching zone from the outside. For this purpose, the film bubble 14 is surrounded by a cooling ring 16, with which a uniform supply of cooling air over the whole periphery of the film bubble is to be achieved.

In the outer circumferential region, the cooling ring 16 has an annular distributing chamber 18, into which a cooling medium, such as air, is supplied with the help of one or more blowers, which are not shown. The distribution chamber 18 is connected over several damming up steps 20 with a ring chamber at 22, which is located further inwards and, at its inner peripheral edge, changes into an outwardly directed outlet gap 23. The stronger the flow of cooling air at the outlet gap 23, the greater is the cooling effect on the film bubble and, consequently, the greater is the thickness, which the film material retains after the solidification of the melt in the circumferential region in question of the film bubble.

Due to the damming up steps 20, the flow resistance for the cooling air is increased to such an extent, that any pressure differences in the distribution chamber 18 can decline, before the cooling air, in a radially inwards directed flow motion, reaches the ring chamber 22. In this way, a largely uniform distribution of flow is achieved over the whole of the periphery of the film bubble 14. However, slight dimensional tolerances during the manufacture of the cooling ring 16 can lead to a slight deviation from the aimed-for uniform flow distribution, with the result that the film, after solidifying, has a sequence of thick and thin sites in the circumferential direction of the film bubble 14. Such thick or thin sites can also be produced by other effects, such as a draft in the room, in which the equipment is installed. Likewise, defects in the extrusion die 10 can lead to nonuniformities in thickness, which would then be intensified during the stretching with uniformly distributed cooling air.

So that such undesirable effects on the thickness profile of the film can be controlled, the cooling ring 16 is divided into several segments by cross members 24, disposed radially in the ring chamber 22, and the flows of cooling air in the individual segments can be controlled independently of one another. In the example shown, a guiding vane 26, the height of which is adjustable and which deflects a portion of the cooling air flowing to a venting opening 28 formed in the cover of the cooling ring, is disposed for this purpose in each segment. In this way, the throughput of cooling air through the segment in question can be varied without an increase in the dynamic pressure, which could react over the distribution chamber 18 on the throughput of cooling air in the adjacent segments. Examples of other measures for segmentally influencing the cooling effect are the supplying of additional cooling air, a simple throttling of the cooling air flowing or the heating or cooling of the air in each segment. A device for measuring the thickness profile in the upper region of the film bubble enables the cooling effect to be controlled segmentally in a closed control circuit.

Downstream from the guiding vanes 26, deflector plates 30 and guiding plates 32 are incorporated in each segment of the cooling ring. So that these deflector and guiding plates can be recognized more clearly, an example is illustrated in FIG. 1, in which the deflector plates 30 and the guiding plates 32 protrude up from the bottom of the ring chamber 22. At the same time, however, they extend only over a portion of the total height of the ring chamber. In practice, however, an embodiment preferably is used, for which the deflector plates 30 and the guiding plates 32 extend over the whole height of the ring chamber 22 and thus reach up to the cover of the ring chamber.

In order to illustrate the mode of action of the deflector plates 30 and of the guiding plates 32, FIG. 2 diagrammatically shows a horizontal partial section through three adjacent segments 34 of the ring chamber 22. It can be seen here that the cross members 24, which separate the individual segments 34 from one another, conically taper inwards, that is, to the center of the cooling ring, so that the segments 34, which extend radially from the outside to the inside, have a constant width over their whole length. Since FIG. 2 shows only the downstream (radially inner) region of the segments 34, the guiding vanes 26 and the venting openings 28 cannot be recognized here. According to FIG. 2, two deflector plates 30 and two guiding plates 32 are provided in each segment 34 and are disposed in each case symmetrically to the longitudinal center axis A of the segment in question. The deflector plates 30, moreover, are set at such an angle to the longitudinal axis of the segment that, seen in the direction of flow, they extend towards the outside and thus approach the adjacent cross member 24. The guiding plates 32 constantly adjoin the downstream ends of the deflector plates 30 and extend once again parallel to the longitudinal direction of the segment. Between each pair of deflector plates 30 and associated guiding plates 32 and the cross member 24 on the same side, a nozzle 36 accordingly is formed, which tapers in the direction of flow of the cooling air. On the other hand, a diffuser 38, which expands in the flow direction of the cooling air, is formed between the two deflector plates 30 of each segment.

In FIG. 2 the original distribution of the flow velocities over the width of the segment 24 is symbolized by arrows B and by a curve C. According to the Hagen-Poiseuille Law (for laminar flow), there is an approximately parabolic flow distribution, similar to that given by curve C. Without the fittings in the segments 34, this flow distribution would be retained as far as the downstream ends of the cross members 34 and only further downstream would there be a certain degree of equalization of the different flow velocities. At the same time, however, under certain circumstances, there could still be certain differences in the flow velocities at the film bubble 14, particularly a decrease in the flow velocity in the regions, which lie in the “wind shadow” of the individual cross members 24.

Due to the installed deflector plates 30 and guiding plates 32, a portion of the cooling air, which is flowing at a high velocity and with a high throughput through the region of the segment in the vicinity of the longitudinal median axis A, is now deflected towards the outside in each segment. Accordingly, due to the action of the nozzles 36, there is a clear increase in the flow velocity in the regions immediately adjoining the cross members 24 and, conversely, due to the action of the diffusers 38, there is a clear decrease in the flow velocity in the central region of the segment. When the flows of cooling air from the individual segments then combine behind the downstream ends of the cross members 24, a flow profile is obtained, which is illustrated by arrows D and curve E, in FIG. 2.

Because of the high flow velocities and throughputs in the regions on either side of each cross member, which are immediately adjacent to the cross member, there is initially a steep velocity gradient behind the downstream ends of the cross members and, with that, a rapid equalization of velocity differences. At the film bubble, a flow distribution is obtained, which is largely uniform or, at the very least, modulated far less in the circumferential direction than is the flow distribution, which results in the absence of the fittings. Accordingly, if the individual segments are controlled correctly, a blown film with a very uniform thickness profile can be produced, which satisfies the highest quality requirement.

FIGS. 3 to 7 illustrate modified embodiments of the invention.

In FIG. 3, the deflector plates 30 and the guiding plates 32 are disposed further upstream in the individual segments 34, so that, behind the downstream ends of the guiding plates 32, a stabilizing space is formed, in which the flow profiles within the individual segments 34 can equality somewhat, before they are combined with one another at the end of the cross members 24.

Conversely it is also possible to dispose the deflector plates 30 and the guiding plates 32 behind what are the downstream ends of the cross members 24 in the flow direction; this is shown diagrammatically in FIG. 4. In this case, the flow can be deflected particularly effectively by the deflector plates 30 in the “wind shadows” behind the cross members 24. The interaction of two adjacent deflector plates which belong to different segments, leads to a nozzle effect here.

In FIG. 4, it is assumed that the cross members 24 are formed only in the radial outer region of the ring chamber 22, so that, behind the cross members within the ring chamber, sufficient space for disposing deflector plates 30 and guiding plates 32 still remains. In a modified embodiment, the deflector plates 30 and the guiding plates could, however, also be disposed in the outlet gap 23, which is directed essentially upward.

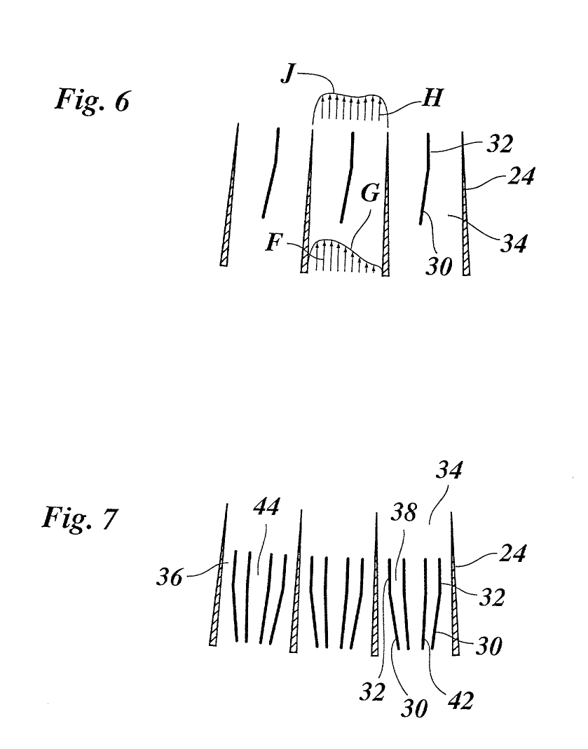

FIG. 5 illustrates an embodiment with a larger number of fittings per segment. In addition to the deflector plates 30 and the guiding plates 32, which are disposed in pairs, a straight continuous guiding plate 40, which divides the segment 34 into two partial segments and forms a diffuser 38 with the two deflector plates 30, is provided here on the central axis of each segment. Alternatively, in each of the partial segments bounded by the guiding plate 40, two pairs of deflector plates 30 and guiding plates 32 could also be provided similarly to the arrangement of FIGS. 2 to 4. In this case, the straight guiding plate 40, together with the adjacent deflector plate, would form a nozzle.

For the embodiments described above, it was assumed that there already was a symmetrical flow distribution in each segment 34 upstream from the deflector plates 30. Accordingly, the fittings are also in all cases disposed symmetrically in each segment for the examples of FIGS. 2 to 5. In principle, however it is also conceivable that the individual segments 34 are formed asymmetrically, so that there is an asymmetric flow distribution upstream from the deflector plate 30. Such an asymmetric flow distribution could also be brought about in the case of symmetrically constructed segments owing to the fact that the cooling air flows helically through the distribution chamber 18 and consequently enters the segments 34 with a tangential component. Such an asymmetric flow distribution is symbolized in FIG. 6 by arrows F and a curve G. As illustrated by arrows H and a curve J in FIG. 6, a homogenized and, at the same time, symmetrized flow profile can then be attained once again at the outlet side by an asymmetric arrangement of fittings, such as a single deflector plate 30 and a single guiding plate 32 in each segment 34.

Finally, FIG. 7 once again shows a symmetric arrangement for which, however, a pair of outer deflector plates 30 and in addition a pair of inner deflector plates 42 with a smaller angle of incidence are provided in each segment 34, so that diffusers 38, 44, nestled one inside the other, are formed.

1. A cooling ring for a film blowing line, with a ring chamber (22), which at a peripheral edge forms an outlet gap (23) for the delivery of a cooling medium onto the film bubble (14) and is divided by radial cross members (24) into several segments (34), and with fittings (30, 32, 40) for homogenizing the flow of the cooling medium in the individual segments (34), wherein the fittings have deflector plates (30), which are disposed obliquely to the radial direction and deflect a portion of the cooling medium from the central regions of the segments (34) to the cross members (24).

2. The cooling ring of claim 1 with a device 26, 28 for segmentally influencing the flow velocity and/or temperature of the cooling medium.

3. The cooling medium of claims 1 and 2, wherein the outlet gap 23 is formed at the inner peripheral edge of the ring chamber (22) and each segment (34) is bounded by wedge-shaped cross members (24), which run together towards the downstream end, and has an essentially constant width over its length.

4. The cooling ring of one of the preceding claims, wherein a guiding plate (32), extending parallel to the longitudinal axis (A) of the segment (34), adjoins each deflection plate (30) upstream.

5. The cooling ring of one of the preceding claims, wherein the fittings comprise straight guiding plates (40) which divide each segment 34 into partial segments, and wherein at least one deflector plate 30 is disposed in each partial segment.

6. The cooling ring of one of the preceding claims, wherein the fittings (30, 32, 40) are disposed symmetrically to the longitudinal median axis (A) of the segment in question (34).

7. The cooling ring of one of the claims 1 to 5, wherein there is an asymmetrical flow distribution (F, G) within each segment (34) upstream from the fittings (30, 32), which are disposed asymmetrically to the longitudinal median axis of the segment in question.

8. The cooling ring of one of the preceding claims, wherein each segment (34) has several deflector plates (30, 42) with different angles of incidence.
